(19) United States
(12) Patent Application Publication
(10) Pub. No.: US 2018/0341768 A1
(43) Pub. Date: Nov. 29, 2018

(54) VIRTUAL MACHINE ATTESTATION

(71) Applicant: Microsoft Technology Licensing, LLC, Redmond, WA (US)

(72) Inventors: Allen Marshall, Snohomish, WA (US); Mathew John, Sammamish, WA (US); Samartha Chandrashekar, Redmond, WA (US)

(21) Appl. No.: 15/607,294

(22) Filed: May 26, 2017

(51) Int. Cl. G06F 21/53; H04L 29/06; G06F 9/455

(52) U.S. Cl. CPC G06F 21/53; H04L 63/0823; H04L 63/102; H04L 63/0428; G06F 9/45558

(57) ABSTRACT

Techniques for tenant management of virtualized computing resources are described. Virtualized computing resources are allocated to a tenant who is allowed to request access to the allocated virtualized computing resources. A request is received for launch of a virtual machine instance based on the allocated virtualized computing resources. In response to the request, a secure enclave is instantiated and information is obtained that is indicative of the host computing environment and the secure enclave. The information is sent to the tenant, and an indication is received from the tenant to launch the virtual machine based on an independent attestation by the tenant based on the sent information. The virtual machine is launched in response to the indication.

### BACKGROUND

Cloud service providers may include data centers that house computer systems and various networking, storage and other components. Cloud service providers may, for example, provide computing services to businesses and individuals as a remote computing service or to provide “software as a service.” To facilitate utilization of data center resources, virtualization technologies allow a physical computing machine to host one or more instances of virtual machines that appear and operate as independent computer machines to a connected computer user. With virtualization, one or more physical computing devices can dynamically create, maintain, or delete virtual machines.

### SUMMARY

Methods and systems for tenant management of virtualized computing resources are described. Virtualized computing resources are allocated to a tenant who is allowed to request access to the allocated virtualized computing resources. A request for launch of a virtual machine instance is received, based on the allocated virtualized computing resources. In response to the request, a secure enclave is instantiated and information indicative of the host computing environment and the secure enclave is obtained. The information is sent to the tenant. An indication is received from the tenant to launch the virtual machine. The indication is based on an independent attestation by the tenant based on the sent information. The virtual machine is launched in response to the indication.

The features, functions, and advantages can be achieved independently in various embodiments or may be combined in yet other embodiments, further details of which can be seen with reference to the following description and illustrations.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a diagram illustrating a mechanism for providing tenant management of virtualized computing resources in accordance with the present disclosure;

FIG. 2 illustrates an example computer system that may be used in some embodiments;

FIG. 3 is a diagram illustrating a mechanism for providing tenant management of virtualized computing resources in accordance with the present disclosure;

FIG. 4 is a diagram illustrating a mechanism for providing tenant management of virtualized computing resources in accordance with the present disclosure;

FIG. 5 is a diagram illustrating a mechanism for providing tenant management of virtualized computing resources in accordance with the present disclosure;

FIG. 6 is a flowchart depicting an example procedure for providing reconfigurable access to computing resources in accordance with the present disclosure; and

FIG. 7 illustrates an example computing system that may be used in some embodiments.

### DETAILED DESCRIPTION OF ILLUSTRATIVE EMBODIMENTS

A service provider may offer computing resources, such as virtualized computing resources and storage resources, to users (who may also be referred to as tenants). A service provider may also be referred to as a host or hoster (a provider of online hosting or other network accessible services). A tenant may be any person or entity who accesses computing resources of the service provider and has a predefined relationship with the service provider. The service provider may, for example, provide a Web-based services platform. Multiple tenants may access the Web-based services platform via a computing device and issue instructions to the Web-based services platform.

A Web-based services platform may also be referred to as a multi-tenant Web-based services platform to denote that multiple tenants may access the platform. In turn, the Web-based services platform may respond to these instructions by performing computing operations on one or more of a plurality of computing devices that make up the Web-based services platform. Other types of resources may be offered by the provider network. The service provider may also provide monitoring and control of a tenant's instances and other resources and applications running on the resources. Such monitoring services may generally be referred to as resource management services. Resource management may be useful for providing security for a tenant's resources and data, and make as efficient as possible the tenant's resource utilization, application performance, and operational health.

In order to provide security assurances to tenants, service providers may inform a tenant that the tenant's resources are running in a secure/guarded host environment via the presence of a vTPM in the virtual machine. Embodiments of the present disclosure are described for providing the tenant with tenant specific information, for example the time of day, location and some other pertinent information that is signed by the hoster and which can be independently attested by the tenant and used by the tenant to decide if the virtual machine should be booted up.

This may be useful where tenant specific policies for virtual machine start-up can be enforced by the tenant, thus providing more direct control of the tenant's virtual machines and their management. Examples of such tenant control may include, for example, virtual machine life cycle (e.g., the virtual machine is not allowed to run past a certain date), or the location of the virtual machine (e.g., the virtual machine is not allowed to run outside of specified geographic areas), etc.

In various embodiments of the disclosure, information is provided to a virtual machine tenant running in a secure/guarded hoster environment. This information is independently attested by the tenant and the tenant can decide if the virtual machine should boot up. The boot-up decision, for example, may therefore be passed to the tenant who can enforce policies directly. In this way, more visibility and control may be provided to the virtual machine tenants of the hoster. In various embodiments, functionality that provides such capabilities may be referred to as a tenant policy enforcement mechanism.

The tenant information, the tenant policy enforcement mechanism, and other details at the tenant side are further described below. Some issues addressed by the disclosed embodiments include, for example, prevention or mitigation of malicious attacks and other security concerns. Such concerns may impede adoption of cloud-based services. Additionally, cloud users may have concerns that virtualization providers can have full administrative access to the tenants' workloads and their content. For enterprise users, the described embodiments may enable compliance to regulations for data-at-rest protections, protections from insider threats, and increased protection from, for example, pass-the-hash attacks. The embodiments may also provide increased protection from malware acting with kernel mode privileges.

The tenant policy enforcement mechanism may provide security assurances such as encryption and data-at-rest protection. For example, a virtual TPM can enable the use of BitLocker from inside a virtual machine (VM), and also support live migration and virtual machine state encryption. The tenant policy enforcement mechanism may also provide admin-lockout, where host administrators cannot access guest virtual machine secrets, and host administrators cannot run arbitrary kernel mode code. Furthermore, the tenant policy enforcement mechanism may allow for attestation where workloads can only run on healthy hosts.

In one embodiment, a virtualized TPM (vTPM) that is not backed by a physical TPM may be projected into the tenant's virtual machine. The vTPM state may be stored as a part of the virtual machine metadata and encrypted using a key provided by a central key service. A client component of the key service may run in all virtualization hosts.

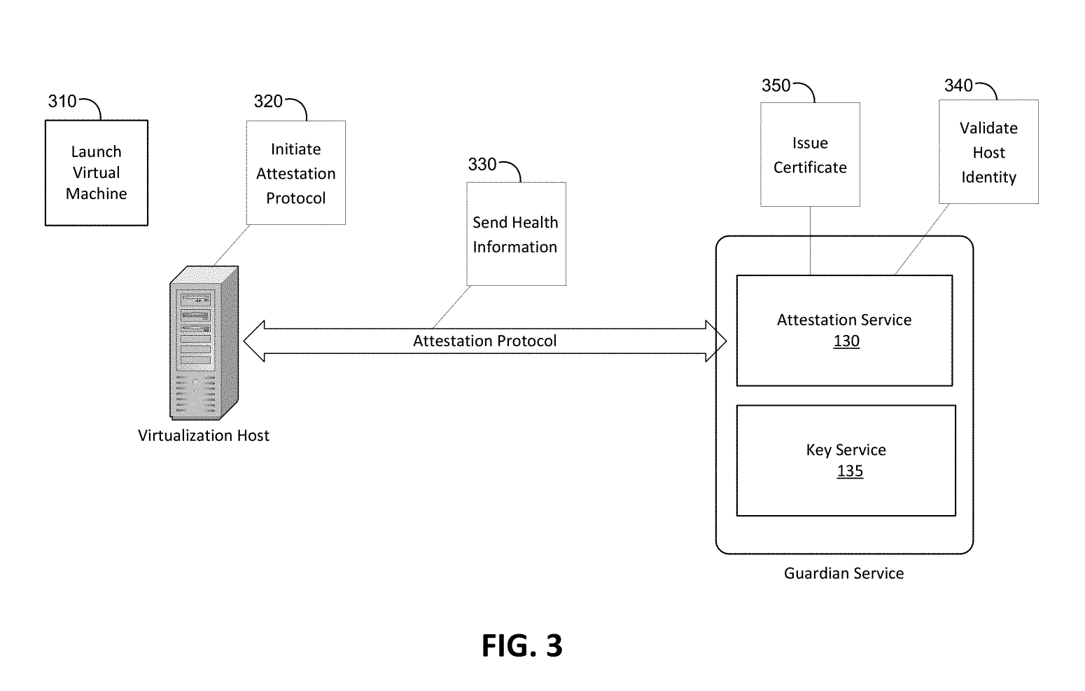

The launching of virtual machines may be contingent on affirmative attestation of the health of the virtualization host using the workflows detailed in FIG. 3. With reference to FIG. 3, in response to a virtual machine being initially booted 310, the virtualization host may initiate an attestation protocol 320 for sending health and other information 330 to the attestation service. The attestation service may validate the host identity and the measurements 340 and other information provided by the virtualization host. The attestation service may also provide a service for key management. The attestation service may issue a signed attestation certification and securely place the attestation certificate 350 in a secure enclave of the host. In an embodiment, this can be performed using a public key of the host.

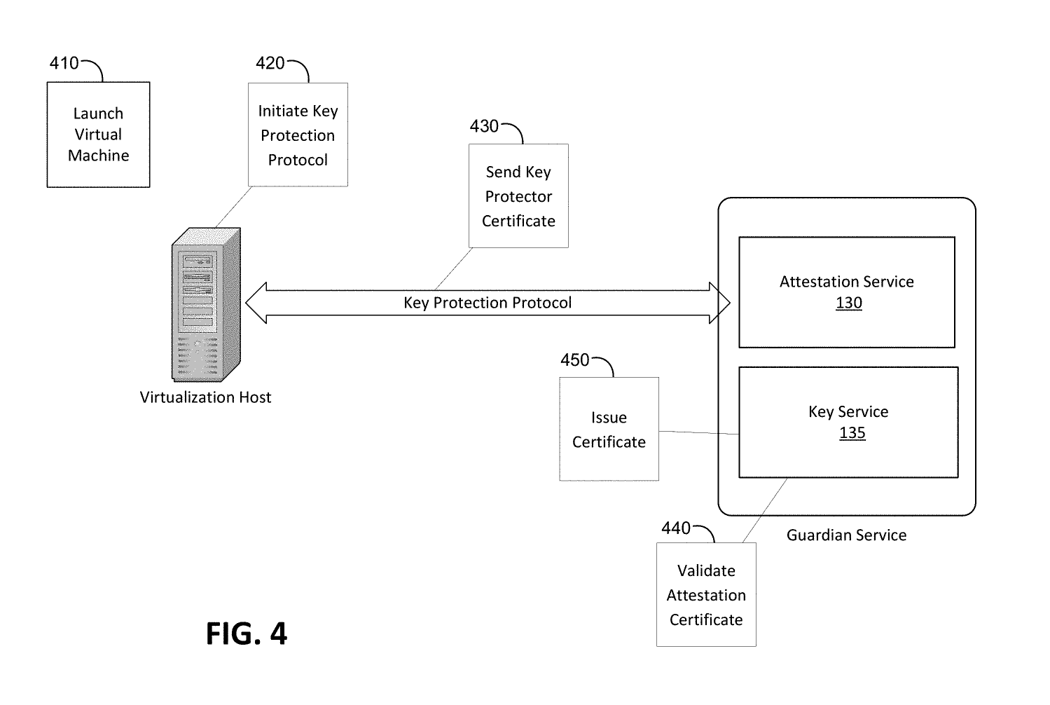

A further embodiment is illustrated with reference to FIG. 4. In response to a virtual machine being initially booted 410, the virtualization host may initiate a key protection protocol 420. The host may send a key protector and attestation certificate 430 to the attestation service. The attestation service may also provide a key service for key management. The key service may validate the attestation certificate 440. The key service may securely send a decryption key to the secure enclave of the host 450. In an embodiment, the key service may encrypt the decryption key with the public key of the secure enclave of the host.

In some embodiments of the disclosure, the definition of host health may be stipulated by the tenant and not by the service provider. Additionally, attestation of host health may be performed by the tenant who is the owner of the VM, rather than being performed by the service provider. In some embodiments, the tenant may execute or cause the execution of the attestation service either at the service provider premises or at the tenant premises. In either case, the attestation service may be controlled, owned and/or operated by the tenant.

The table below indicates various configurations that may be implemented to reduce the level of trust that tenants will have to place in their service provider.

| | | Attestation | Attestation |
|---|---|---|---|
| | Definition of host | of host health | service |
| | health supplied by | performed by | run at |
| Conventional | OEM | Service Provider | Service Provider |
| Proposed | OEM | Tenant | Service Provider |
| configurations | OEM | Tenant | Tenant |
| | Service Provider | Service Provider | Service Provider |
| | Service Provider | Tenant | Service Provider |
| | Service Provider | Tenant | Tenant |
| | Tenant | Service Provider | Service Provider |
| | Tenant | Tenant | Service Provider |
| | Tenant | Tenant | Tenant |

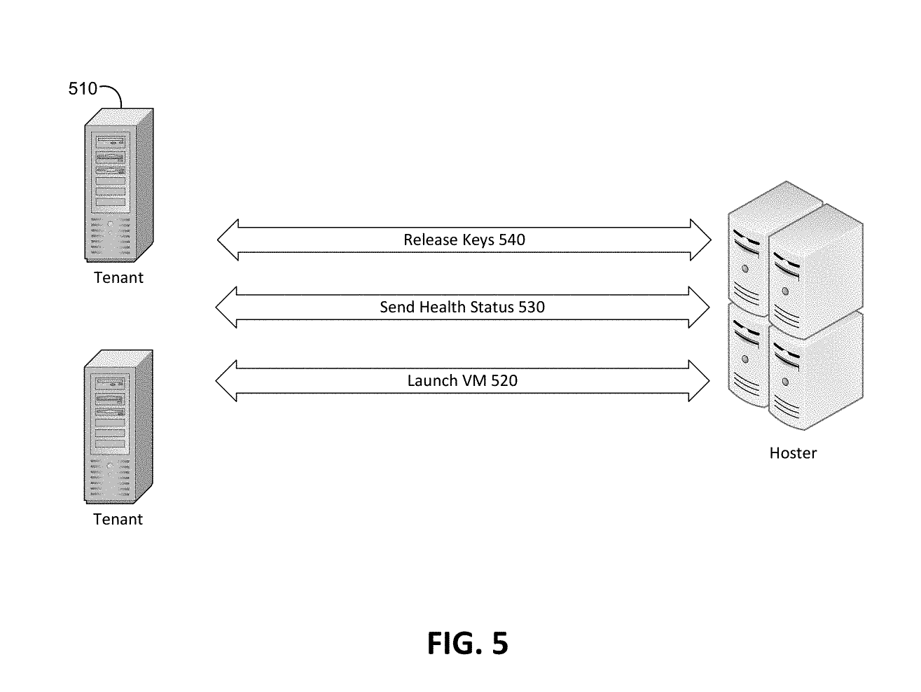

With reference to FIG. 5, illustrated is an example workflow for tenant attestation. Various tenants may have their own administrators that may implement attestation policies at the tenant 510. When a tenant attempts to start a virtual machine 520 allocated to the tenant by the service provider, in response the host may sent health status of the host to the tenant 530. The status information may be sent via the hoster network. The tenant may receive the status information and verify that the information meets the tenant's attestation policies. If the attestation passes, then the tenant may release keys needed to run its allocated virtual machines at the hoster 540.

With reference to the workflow shown in FIG. 5, the figure illustrates that in one embodiment:

1) Information for the health of the virtualization host may be provided to the virtual machine and sent to the virtual machine owner (tenant) for attestation.

a. The information may be sent via connectivity between the virtual machine and its attestation server.

b. The information may be sent before the virtual machine boots up using pre-boot components in the virtual machine.

c. Full launch of the virtual machine will fail if attestation checks do not pass.

With continued reference to the workflow shown in FIG. 5, the figure illustrates that in one embodiment:

2) Information for the health of the virtualization host may be sent to the owner of the virtual machine (tenant) for attestation directly from the virtualization host.

a. The information may be sent via connectivity between the host fabric and the attestation server for the virtual machine in question.

b. Launch of the virtual machine will fail if attestation checks do not pass.

In both cases, the information is tamper-protected.

Various aspects of the disclosure are described with regard to certain examples and embodiments, which are intended to illustrate example environments for implemented the disclosure but not to limit the disclosure.

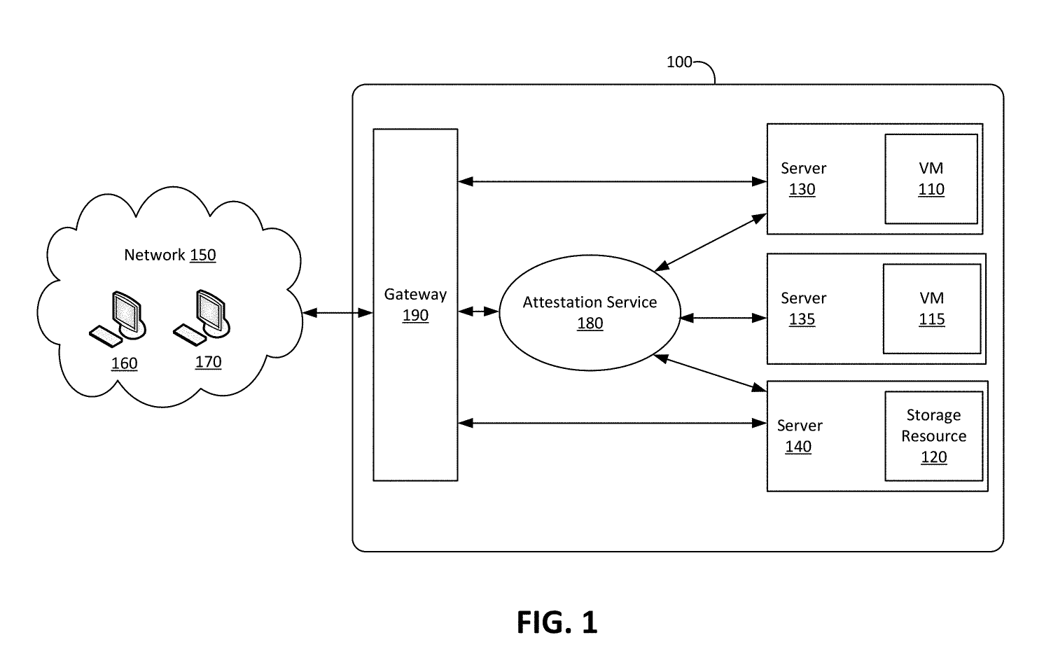

FIG. 1 is a diagram illustrating a system 100 including a framework for providing virtualization services and attestation mechanisms in accordance with the present disclosure. In FIG. 1, system 100 may include a virtual machine 110, a virtual machine 115, and a storage resource 120 that may execute, for example, on one or more server computers 130, 135, and 140, respectively. It will be appreciated that some embodiments may involve additional resources of various types that may be provided on additional server computers.

FIG. 1 also illustrates a public network 150 that may include one or more computers, such as computers 160 and 170. According to one embodiment, resources 110, 115, and 120 may be configured to provide computing services to a computer user or tenant (not shown) of public network 150 via gateway 190 and computers 160 and 170. For example, reserved resource 110 may provide a set of remote access enterprise applications to a group of users who may, for example, be employees of an enterprise tenant.

A request may be sent to an attestation service 180 for securely providing host information to tenants for attestation. In some embodiments, the request may be generated in response to a request for launching a virtual machine received from the user at computer 160 or 170. In other embodiments, the request may be received from one or more services at the service provider. In response to receipt of the request, attestation service 180 may log the request and provide updates as to the status of the request. The attestation service 180 may communicate with other services to facilitate: (1) processing of the request, (2) collection of data pertaining to request, and (3) generating interfaces to provide results of the request. The attestation service 180 may, for example, provide an interface for facilitating submission of the request. The attestation service 180 may further provide an interface for viewing the results of the request and modifying or cancelling the request.

Attestation service 180 may be made accessible via an application programming interface (API) or a user interface that may be accessed via a Web browser or other input mechanisms.

Attestation service 180 may also provide tenants with the ability to request and receive notifications or to take specified actions depending on the results of the attestation checks. For example, a tenant may authorize the host to prevent future launch of virtual machines that fail attestation checks. In some embodiments, data associated with such virtual machines may be retained for a predetermined time to allow tenants to retrieve historical data for review and analysis.

A user interface may be provided to allow access to the attestation service 180. Additionally or optionally, an option to request diagnostics may be provided when configuring or launching attestation services. A user interface may also be provided to allow a tenant to view all of a tenant's virtual machine launch and attestation requests. The user interfaces may be interactive and the tenant may be able to select parameters such as a time range.

One useful result of retaining information is to allow the host or tenant to identify whether the source of a particular issue is at the service provider or outside of the service provider's service boundaries and likely the result of the tenant-side configuration. In this way next steps for further issue resolution can be taken focused at the appropriate source.

In some embodiments, an API may be provided to facilitate requests for virtual machine requests, sending hoster health and other information, and providing attestation information. For example, the API can be called with information such as a virtual machine identifier. After the API is called, in one embodiment the attestation service 180 may take actions such as:
Invoke an attestation service.
Access activity logs for the tenant's resources.
Retrieve configuration of the tenant's resources.
Retrieve connection states for the tenant's resources.
Call available APIs that can provide certificates and keys for the tenant's resources.

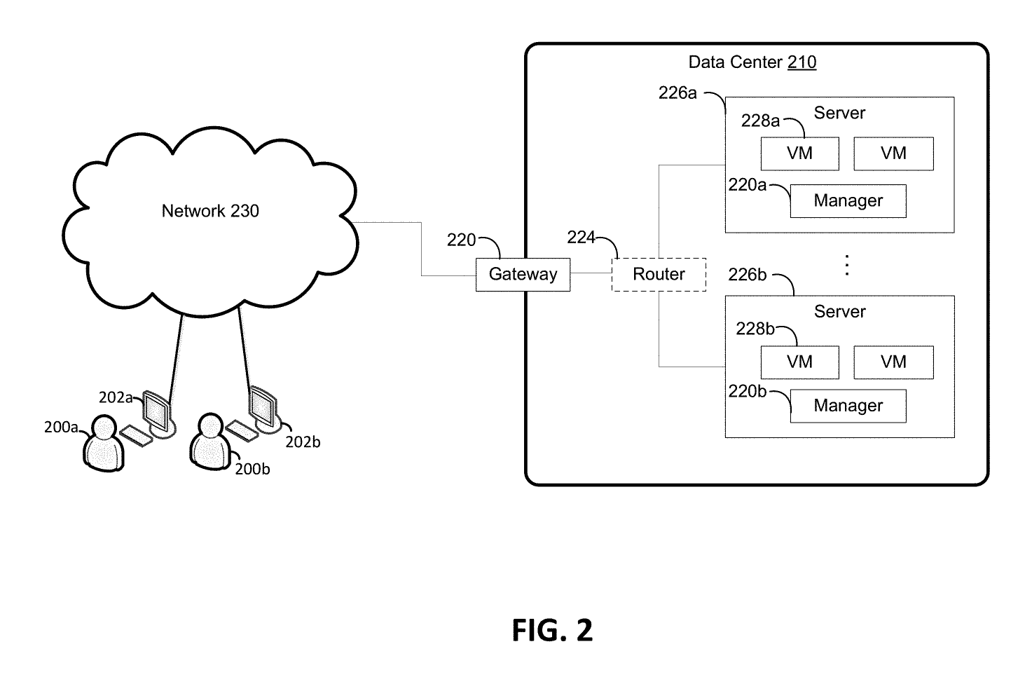

FIG. 2 illustrates an example computing environment in which the embodiments described herein may be implemented. FIG. 2 is a diagram schematically illustrating an example of a data center 220 that can provide virtualized computing resources to multiple users 200 by way of computers 202 via a communication network 230. Data center 220 may be configured to provide virtualized computing resources for executing applications. The computing resources provided by data center 220 may include various types of resources, such as data processing resources, data storage resources, data communication resources, and the like. Each type of computing resource may be general-purpose or may be available in a number of specific configurations. For example, data center 220 may include servers 226 that provide computing resources available as virtual machine instances 228. The virtual machine instances 228 may be configured to execute applications, including Web servers, application servers, media servers, database servers, and the like. Other resources that may be provided include data storage resources (not shown), and may include file storage devices, block storage devices, and the like.

The availability of virtualization technologies for computing hardware has provided benefits for providing large scale computing resources for tenants and allowing computing resources to be efficiently and securely shared between multiple tenants. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that spans multiple distinct physical computing systems.

Referring to FIG. 2, communications network 230 may, for example, be a publicly accessible network of linked networks and possibly operated by various distinct parties, such as the Internet. In other embodiments, communications network 230 may be a private network, such as, for example, a corporate or university network that is wholly or partially inaccessible to non-privileged users. In still other embodiments, communications network 230 may include one or more private networks with access to and/or from the Internet.

Communication network 230 may provide access to computers 202. User computers 202 may be computers utilized by tenants 200 or other tenants of data center 210. For instance, user computer 202a or 202b may be a server, a desktop or laptop personal computer, a tablet computer, a wireless telephone, a personal digital assistant (PDA), an e-book reader, a game console, a set-top box, or any other computing device capable of accessing data center 210. User computer 202a or 202b may connect directly to the Internet (e.g., via a cable modem or a Digital Subscriber Line (DSL)). Although only two user computers 202a and 202b are depicted, it should be appreciated that there may be multiple user computers.

User computers 202 may also be utilized to configure aspects of the computing resources provided by data center 210. In this regard, data center 210 might provide a Web interface through which aspects of its operation may be configured through the use of a Web browser application program executing on user computer 202. Alternatively, a stand-alone application program executing on user computer 202 might access an application programming interface (API) exposed by data center 210 for performing the configuration operations. Other mechanisms for configuring the operation of the data center 210, including deploying updates to an application, might also be utilized.

Servers 226 shown in FIG. 2 may be standard servers configured appropriately for providing the computing resources described above and may provide computing resources for executing one or more applications. In one embodiment, the computing resources may be virtual machine instances 228. In the example of virtual machine instances, each of the servers 226 may be configured to execute an instance manager 220a or 220b capable of executing the virtual machine instances. The instance managers 220 may be a virtual machine monitor (VMM) or another type of program configured to enable the execution of virtual machine instances 228 on server 226, for example. As discussed above, each of the virtual machine instances 228 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 210 shown in FIG. 2, a router 224 may be utilized to interconnect the servers 226a and 226b. Router 224 may also be connected to gateway 220 which is connected to communications network 230. Router 224 may manage communications within networks in data center 210, for example by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In some embodiments, one or more of the virtual machine instances 228 of data center 210 may form part of one or more networks. In some embodiments, gateway 220 may be used to provide network address translation (NAT) functionality to a group of virtual machine instances and allow the virtual machine instances of the group to use a first group of internal network addresses to communicate over a shared internal network and to use a second group of one or more other external network addresses for communications between virtual machine instances of the group and other computing systems or virtual machine instances that are external to the group. An IP address is one example of a network address that is particularly applicable to the TCP/IP context in which some embodiments of the present disclosure can be implemented. The use of IP addresses herein is intended to be illustrative of network addresses and not limiting as to the scope of the described concepts.

Virtual machine instances 228 may be assigned a private network address (not shown). For example, the private network addresses may be unique with respect to their respective private networks but not guaranteed to be unique with respect to other computing systems that are not part of the private network. IP addresses are used to illustrate some example embodiments in the present disclosure. However, it should be understood that other network addressing schemes may be applicable and are not excluded from the scope of the present disclosure.

Gateway 220 may operate to manage both incoming communications to data center 210 from communication network 230 and outgoing communications from data center 210 to communication network 230. For example, if virtual machine instance 226a sends a message (not shown) to computer 202a, virtual machine instance 228a may create an outgoing communication that includes network address on a first network (e.g., an external public IP address) for computer 202a as the destination address and include a network address on a second network (e.g., a private IP address) for virtual machine instance 228a as the source network address. Router 224 may then use the destination address of the outgoing message to direct the message to gateway 220 for handling.

It should be appreciated that the network topology illustrated in FIG. 2 has been greatly simplified and that many more networks and networking devices may be utilized to interconnect the various computing systems disclosed herein. These network topologies and devices should be apparent to those skilled in the art.

It should also be appreciated that data center 210 described in FIG. 2 is merely illustrative and that other implementations might be utilized. Additionally, it should be appreciated that the functionality disclosed herein might be implemented in software, hardware, or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

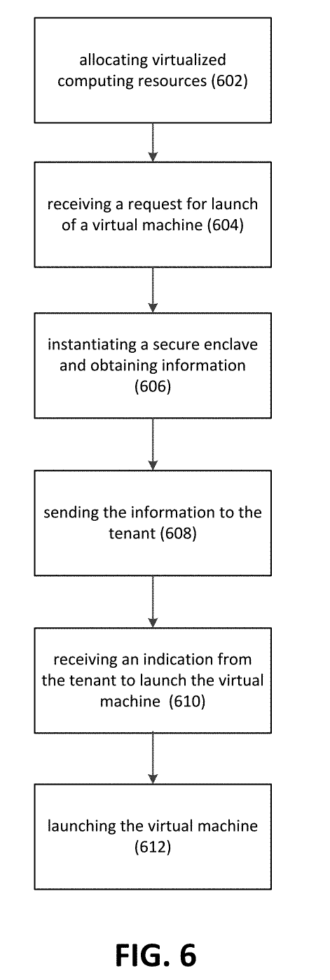

FIG. 6 illustrates an example operational procedure for providing tenant management of virtualized computing resources. Referring to FIG. 6, operation 600 begins the operational procedure. Operation 600 may be followed by operation 602. Operation 602 illustrates allocating virtualized computing resources to a tenant who is allowed to request access to the allocated virtualized computing resources.

Operation 602 may be followed by operation 604. Operation 604 illustrates receiving a request for launch of a virtual machine instance based on the allocated virtualized computing resources. Operation 604 may be followed by operation 606. Operation 606 illustrates in response to the request, instantiating a secure enclave and obtaining information indicative of the host computing environment and the secure enclave.

Operation 606 may be followed by operation 608. Operation 608 illustrates sending the information to the tenant.

Operation 608 may be followed by operation 610. Operation 610 illustrates receiving an indication from the tenant to launch the virtual machine based on an independent attestation by the tenant based on the sent information. Operation 610 may be followed by operation 612. Operation 612 illustrates launching the virtual machine in response to the indication.

In an embodiment, a system for providing tenant management of virtualized computing resources may be implemented. The system comprises a processor and a memory storing instructions that, when executed by the processor, configure the system to:

allocate virtualized computing resources to a tenant who is allowed to request access to the allocated virtualized computing resources;

receive a request for launch of a virtual machine instance based on the allocated virtualized computing resources;

in response to the request, instantiate a secure enclave and obtaining information indicative of a host computing environment and the secure enclave;

sending the information to the tenant;

receiving an indication from the tenant to launch the virtual machine based on an independent attestation by the tenant based on the sent information; and

launching the virtual machine in response to the indication.

In an embodiment, the secure enclave is provided using a virtualized TPM (vTPM).

In an embodiment, the information includes the vTPM state.

In an embodiment, the vTPM state is encrypted using a key provided by a central key service.

In an embodiment, the system further comprises initiating an attestation service.

In an embodiment, the system further comprises initiating an attestation protocol for sending host health information to the attestation service.

In an embodiment, the attestation service is configured to validate an identity of the host and the host health information.

In an embodiment, the attestation service is configured to issue a signed attestation certification and securely place the attestation certificate in the secure enclave.

In an embodiment, the system further comprises initiating a key protection protocol.

In an embodiment, the system further comprises securely sending a decryption key to the secure enclave.

In an embodiment, the system further comprises encrypting the decryption key with a public key of the secure enclave.

In an embodiment, the system further comprises receiving keys usable to allow for the launch of the virtual machine.

In an embodiment, the system further comprises shutting down the virtual machine in response to receiving indication that the independent attestation has failed.

In an embodiment, a method for providing tenant management of virtualized computing resources may be implemented. The method comprises:

sending to a host by a computing device, a request to launch a virtual machine instance;

receiving, by the computing device from the host, information indicative of the host computing environment and a secure enclave for launching the virtual machine instance;

verifying, by the computing device, that the information meets a tenant attestation policy; and

in response to verifying that the information meets a tenant attestation policy, sending, by the computing device to the host, an indication to launch the virtual machine instance.

In an embodiment, the information is received from an attestation service configured to validate an identity of the host and the host health information.

In an embodiment, the method further comprises releasing keys usable by the host to allow for the launching of the virtual machine.

In an embodiment, the method further comprises in response to determining that the information does not meet the tenant attestation policy, sending, by the computing device to the host, an indication to cancel launch of the virtual machine instance.

In an embodiment, the tenant attestation policy is defined and controlled by the tenant.

In an embodiment, a non-transitory computer-readable storage medium having stored thereon computer-readable instructions may be implemented. The computer-readable instructions comprise instructions that upon execution on a computing device, at least cause:

in response to a request from a host executing a secure enclave for instantiating a virtual machine allocated to a tenant user, validating an identity of the host;

obtaining information indicative of the host computing environment and the secure enclave; and

signing an attestation certification and placing the attestation certificate in the secure enclave;

wherein the information is usable by the tenant to verify compliance with a tenant attestation policy.

In an embodiment, the computer-readable medium further comprises computer-readable instructions that upon execution on a computing node, at least cause executing a key service configured to validate the attestation certificate.

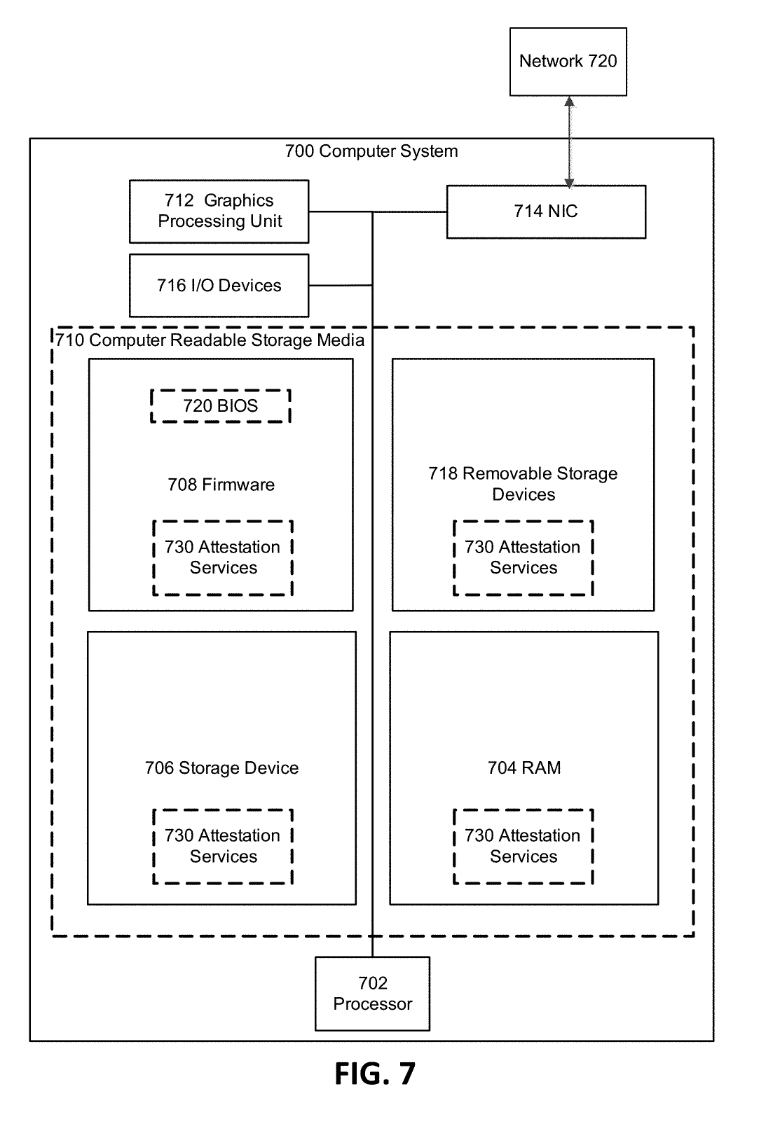

Referring to FIG. 7, an example computing environment in which embodiments of the present disclosure may be implemented is depicted and generally referenced as computing environment 700. As utilized herein, the phrase “computing environment” generally refers to a computing device with processing power and storage memory, which supports operating software that underlies the execution of software, applications, and computer programs thereon.

As shown by FIG. 7, computing environment 700 includes processor 702 (e.g., an execution core) that is interconnected by one or more system buses that couple various system components to processor 702. While one processor 702 is shown in the example depicted by FIG. 7, one skilled in the art will recognize that computing environment 700 may have multiple processors (e.g., multiple execution cores per processor substrate and/or multiple processor substrates each having multiple execution cores) that each receive computer-readable instructions and process them accordingly. The one or more system buses may be any of several types of bus structures including a memory bus or memory controller, a peripheral bus, and a local bus using any of a variety of bus architectures. In an embodiment, computing environment 700 also includes a host adapter, Small Computer System Interface (SCSI) bus, and an external storage device connected to the SCSI bus.

Computing environment 700 also typically includes or has access to various computer-readable media. Computer-readable media is any available media accessible to computing environment 700 that embodies computer-readable, processor-executable instructions. By way of example, and not limitation, computer-readable media includes computer-readable storage media 710 and communication media. Aspects of the present disclosure are implemented by way of computer-readable, processor-executable instructions that are stored on or transmitted across some form of computer-readable media.

Communication media typically embodies computer-readable instructions, data structures, program modules or other data in a modulated data signal such as a carrier wave or other transport mechanism and includes any information delivery media. “Modulated data signal”, as used herein, refers to a signal having one or more characteristics that each may be configured or modified to encode data into the signal for propagation through a communication channel. Examples of such communication channels include wired media such as a wired network or direct-wired connection, and wireless media such as acoustic, RF, infrared and other wireless media.

Computer-readable storage media 710 can include, for example, random access memory (“RAM”) 704; storage device 706 (e.g., electromechanical hard drive, solid state hard drive, etc.); firmware 708 (e.g., FLASH RAM or ROM); and removable storage devices 718 (e.g. CD-ROMs, floppy disks, DVDs, FLASH drives, external storage devices, etc). It should be appreciated by those skilled in the art that other types of computer-readable storage media can be used such as magnetic cassettes, flash memory cards, and/or digital video disks. Generally, such computer-readable storage media can be used in some embodiments to store processor executable instructions tangibly embodying aspects of the present disclosure. Consequently, computer-readable storage media explicitly excludes signals per se.

Computer-readable storage media 710 can provide non-volatile and/or volatile storage of computer-readable, processor-executable instructions, data structures, program modules and other data for computing environment 700. A basic input/output system (BIOS″) 720, containing the basic routines that help to transfer information between elements within computing environment 700, such as during start up, can be stored in firmware 708. A number of programs may be stored on firmware 708, storage device 706, RAM 704, and/or removable storage devices 718. These programs can include an operating system and/or application programs. In a specific embodiment, computer-readable storage media 710 of a computing environment 700 can store attestation services 730, which is described in more detail in the following paragraphs. In this example embodiment, attestation services 730 can be executed by processor 702 thereby transforming computing environment 700 into a computer environment configured for a specific purpose, i.e., a computer environment configured according to techniques described in this disclosure.

With continued reference to FIG. 7, commands and information may be received by computing environment 700 through input/output devices (“I/O devices”) 776. I/O devices 776 include one or more input devices, output devices, or a combination thereof. Examples of input devices include a keyboard, a pointing device, a touchpad, a touchscreen, a scanner, a microphone, a joystick, and the like. Examples of output devices include a display device, an audio device (e.g. speakers), a printer, and the like. These and other I/O devices are often connected to processor 702 through a serial port interface that is coupled to the system bus, but may be connected by other interfaces, such as a parallel port, game port, or universal serial bus (USB). A display device can also be connected to the system bus via an interface, such as a video adapter which can be part of, or connected to, a graphics processor unit.

Computing environment 700 may operate in a networked environment and receive commands and information from one or more remote computers via logical connections to the one or more remote computers, such as a remote computer. The remote computer may be another computer, a server, a router, a network PC, a peer device or other common network node, and typically can include many or all of the elements described above relative to computing environment 700.

When used in a LAN or WAN networking environment, computing environment 700 can be connected to the LAN or WAN through network interface card (“NIC”) 774. NIC 774, which may be internal or external, can be connected to the system bus. In a networked environment, program modules depicted relative to computing environment 700, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

In a networked environment, program modules depicted relative to computing environment 700, or portions thereof, may be stored in a remote memory storage device accessible via NIC 774. It will be appreciated that the network connections shown are exemplary and other means of establishing a communications link between the computers may be used. In an embodiment where computing environment 700 is configured to operate in a networked environment, the operating system is stored remotely on a network, and computing environment 700 may netboot this remotely-stored operating system rather than booting from a locally-stored operating system. In an embodiment, computing environment 700 comprises a thin client having an operating system that is less than a full operating system, but rather a kernel that is configured to handle networking and display output. FIG. 7 also shows network 720 which may be used to communicate to other devices as further described herein.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

What is claimed:

1. A system for providing tenant management of virtualized computing resources, the system comprising a processor and a memory storing instructions that, when executed by the processor, configure the system to:
allocate virtualized computing resources to a tenant who is allowed to request access to the allocated virtualized computing resources;
receive a request for launch of a virtual machine instance based on the allocated virtualized computing resources;
in response to the request, instantiate a secure enclave and obtain information indicative of a host computing environment and the secure enclave;
send the information to the tenant;
receive an indication from the tenant to launch the virtual machine based on an independent attestation by the tenant based on the sent information; and
launching the virtual machine in response to the indication.

2. The system according to claim 1, wherein the secure enclave is provided using a virtualized TPM (vTPM).

3. The system according to claim 2, wherein the information includes a state of the vTPM.

4. The system according to claim 3, wherein the vTPM state is encrypted using a key provided by a central key service.

5. The system according to claim 1, further comprising instructions that, when executed by the processor, configure the system to initiate an attestation service.

6. The system according to claim 5, further comprising instructions that, when executed by the processor, configure the system to initiate an attestation protocol for sending host health information to the attestation service.

7. The system according to claim 6, wherein the attestation service is configured to validate an identity of the host and the host health information.

8. The system according to claim 5, wherein the attestation service is configured to issue a signed attestation certification and securely place the attestation certificate in the secure enclave.

9. The system according to claim 1, further comprising instructions that, when executed by the processor, configure the system to initiate a key protection protocol.

10. The system according to claim 1, further comprising instructions that, when executed by the processor, configure the system to securely send a decryption key to the secure enclave.

11. The system according to claim 10, further comprising instructions that, when executed by the processor, configure the system to encrypt the decryption key with a public key of the secure enclave.

12. The system according to claim 1, further comprising instructions that, when executed by the processor, configure the system to receive keys usable to allow for the launch of the virtual machine.

13. The system according to claim 1, further comprising instructions that, when executed by the processor, configure the system to shut down the virtual machine in response to receiving indication that the independent attestation has failed.

14. A method for providing tenant management of virtualized computing resources, the method comprising:
sending, to a host by a computing device, a request to launch a virtual machine instance;
receiving, by the computing device from the host, information indicative of the host computing environment and a secure enclave for launching the virtual machine instance;
verifying, by the computing device, that the information meets a tenant attestation policy; and
in response to verifying that the information meets a tenant attestation policy, sending, by the computing device to the host, an indication to launch the virtual machine instance.

15. The method of claim 14, wherein the information is received from an attestation service configured to validate an identity of the host and health information of the host.

16. The method of claim 14, further comprising releasing keys usable by the host to allow for the launching of the virtual machine.

17. The method of claim 14, further comprising in response to determining that the information does not meet the tenant attestation policy, sending, by the computing device to the host, an indication to cancel launch of the virtual machine instance.

18. The method of claim 14, wherein the tenant attestation policy is defined and controlled by the tenant.

19. A non-transitory computer-readable storage medium having stored thereon computer-readable instructions, the computer-readable instructions comprising instructions that upon execution on a computing device, at least cause:
in response to a request, from a host executing a secure enclave, to instantiate a virtual machine allocated to a tenant user, validating an identity of the host;
obtaining information indicative of the host computing environment and the secure enclave; and
signing an attestation certification and placing the attestation certificate in the secure enclave;
wherein the information is usable by the tenant user to verify compliance with a tenant attestation policy.

20. The computer-readable medium of claim 19, further comprising computer-readable instructions that upon execution on a computing device, at least cause executing a key service configured to validate the attestation certificate.
